(19) United States
(12) Patent Application Publication
(10) Pub. No.: US 2016/0277182 A1
(43) Pub. Date: Sep. 22, 2016

(54) COMMUNICATION SYSTEM AND MASTER APPARATUS

(71) Applicant: MITSUBISHI ELECTRIC CORPORATION, Tokyo (JP)

(72) Inventor: Daisuke SUZUKI, Tokyo (JP)

(73) Assignee: Mitsubishi Electric Corporation, Tokyo (JP)

(21) Appl. No.: 15/033,865

(22) PCT Filed: Nov. 18, 2013
(86) PCT No.: PCT/JP2013/081055

§ 371 Date: May 2, 2016

(51) Int. Cl. H04L 9/08

(52) U.S. Cl. CPC H04L 9/088; H04L 9/0861

(57) ABSTRACT

In a setting phase, a master apparatus M assigns addresses Aₛ₁ to Aₛ₃ to slave devices S1 to S3, respectively, and transmits random numbers R1 to R3 to the slave device S1 to S3 using the assigned addresses. When the random numbers are received, the slave devices S1 to S3 encrypt unique ID_{S1} to ID_{S3} by a secret key MK to generate encrypted data C1 to C3. The master apparatus M obtains the encrypted data C1 to C3 from the slave devices S1 to S3, decrypts the obtained encrypted data C1 to C3 by a secret key MK held by the master apparatus M, and generates a correspondence table which indicates a correspondence between the decrypted unique ID_{S1} to ID_{S3} and the addresses Aₛ₁ to Aₛ₃ used to obtain the unique ID_{S1} to ID_{S3}.

### TECHNICAL FIELD

The present invention relates to a communication system including a plurality of apparatuses and a master apparatus that communicates with the plurality of apparatuses, and to a master apparatus.

### BACKGROUND ART

Recently, with networking of embedded devices such as typically a cellular phone, there is increasing need for an embedded device to perform processes related to information security in order to maintain the confidentiality and integrity of data handled by the embedded device and authenticate the embedded device itself. These processes related to information security are realized by an encryption algorithm and an authentication algorithm.

Let us now consider a system in which two LSIs perform authentication to check with each other that the connected device is a legitimate device. A specific example of this is a case where an LSI mounted on a cellular phone body authenticates an LSI mounted on its battery to check that the battery is the one that is allowed to be connected. That is, a main device being a master checks the validity and authenticity of a peripheral device being a slave. Such a function is generally realized by an authentication protocol using cryptography.

As a conventional device authentication system, an authentication method described in International Standard ISO/IEC9798-2 will be described below.
(1) A secret key MK is stored in an LSI mounted on a slave S in advance. The secret key MK is also registered in a master M.
(2) In a case where the master M authenticates the slave S, the master M first generates a random number r and transmits the random number r to the slave S.
(3) The slave S encrypts ID_{M}, which is an identifier (unique ID) of the master M, and the received random number r using the secret key MK, and transmits a result thereof to the master M. This will be represented as c=E_{MK}(r∥ID_{M}), where ∥ denotes bit concatenation.
(4) The master M decrypts the encrypted data c using the secret key MK, and checks if coincidence occurs with the transmitted random number r and its own ID_{M}. If no coincidence occurs, the possibility of a counterfeit product is notified. The point of this protocol is that the master M and the slave S each have the same secret key MK.

Such a basic authentication method is described in Patent Literature 1 (WO2007-132518). The reason why the identifier ID_{M} of the master is involved in the authentication protocol described above is that it is involved to indicate that the encrypted data c is encrypted data calculated by the slave S for authentication with the master M having the identifier ID_{M}. That is, it is involved to prevent the encrypted data c calculated by the slave S for the master M from being misused for authentication with another master X.

### CITATION LIST

### Patent Literature

Patent Literature 1: WO2007/132518

### SUMMARY OF INVENTION

### Technical Problem

Let us now consider a case where a plurality of slaves is connected to a master by daisy chain connection, such as typically JTAG or SCSI. In this case, a slave near the master is naturally placed in the same situation as a man-in-the-middle attack in relation to a slave device at a later position. That is, if the slave near the master is a fraudulent product, it is possible for this slave to pass authentication by making the slave at the later position, which is an authentic product, calculate a response and returning a result thereof to the master.

Even if all are authentic products, the authentication protocol described above cannot recognize the configuration including their order. This means that if a diversity of slave devices are connected, the validity of their configuration cannot be recognized by authentication.

As an example of this, a programmable logic controller (to be hereinafter referred to as a PLC) is pointed out. The PLC includes a CPU unit as a device corresponding to a master, and has a “diversity” of devices corresponding to slaves, such as an input unit, an output unit, an analog input unit, an analog output unit, a positioning unit, and a link unit. There may be restrictions on connection of slave devices, such as a connection order, the maximum number of connections allowed for each unit, and units not allowed to be used simultaneously. It is thus inadequate to allow connection with the CPU unit only by authentication simply as an authentic product.

It is an object of the present invention to provide a component authentication system suitable for a system in which a plurality of diverse slaves is connected to one master apparatus.

### Solution to Problem

A communication system according to the present invention includes:

a master apparatus; and

a plurality of apparatuses, each being connected at each connection position which determines an address order and performing communication with the master apparatus,

each apparatus of the plurality of apparatuses including:
a storage part to store an identifier and first secret information; and
an encryption part to encrypt the identifier by the first secret information,

the master apparatus including:
a master storage part to store second secret information;
a master communication part to perform communication with each apparatus; and
a master control part to assign, to each apparatus, an address in accordance with the address order and to be used for the communication, as an initial address, and using the initial address, transmit a first identifier request for requesting an identifier to each apparatus from the master communication part,

the encryption part of each apparatus, when the first identifier request is received, encrypting the identifier by the first secret information to generate an encrypted identifier,

the master control part obtaining the encrypted identifier from each apparatus with the master communication part, decrypting the obtained encrypted identifier by the second secret information, and generating correspondence information which indicates a correspondence between the decrypted identifier and the initial address used to obtain the decrypted identifier.

### Advantageous Effects of Invention

According to the present invention, an authentication system suitable for a system in which a plurality of diverse slaves is connected to a master apparatus can be provided.

### BRIEF DESCRIPTION OF DRAWINGS

FIG. 1 is a configuration diagram of a component authentication system according to a first embodiment;

FIG. 2 is a sequence diagram of a setting phase according to the first embodiment;

FIG. 3 is a diagram illustrating a setting phase correspondence table according to the first embodiment;

FIG. 4 is a sequence diagram of a communication phase according to the first embodiment;

FIG. 5 is another sequence diagram of the communication phase according to the first embodiment;

FIG. 6 is a diagram illustrating a communication phase correspondence table in the sequence of FIG. 5;

FIG. 7 is a configuration diagram of a component authentication system according to a second embodiment;

FIG. 8 is a diagram illustrating a setting phase correspondence table according to the second embodiment;

FIG. 9 is a diagram illustrating a communication phase correspondence table according to the second embodiment;

FIG. 10 is a sequence diagram of a communication phase according to the second embodiment;

FIG. 11 is a flowchart illustrating the content of processing in ST406 of FIG. 10;

FIG. 12 is a flowchart in which ST4062 of FIG. 11 is deleted; and

FIG. 13 is a diagram illustrating a hardware configuration according to a third embodiment.

### DESCRIPTION OF EMBODIMENTS

### First Embodiment

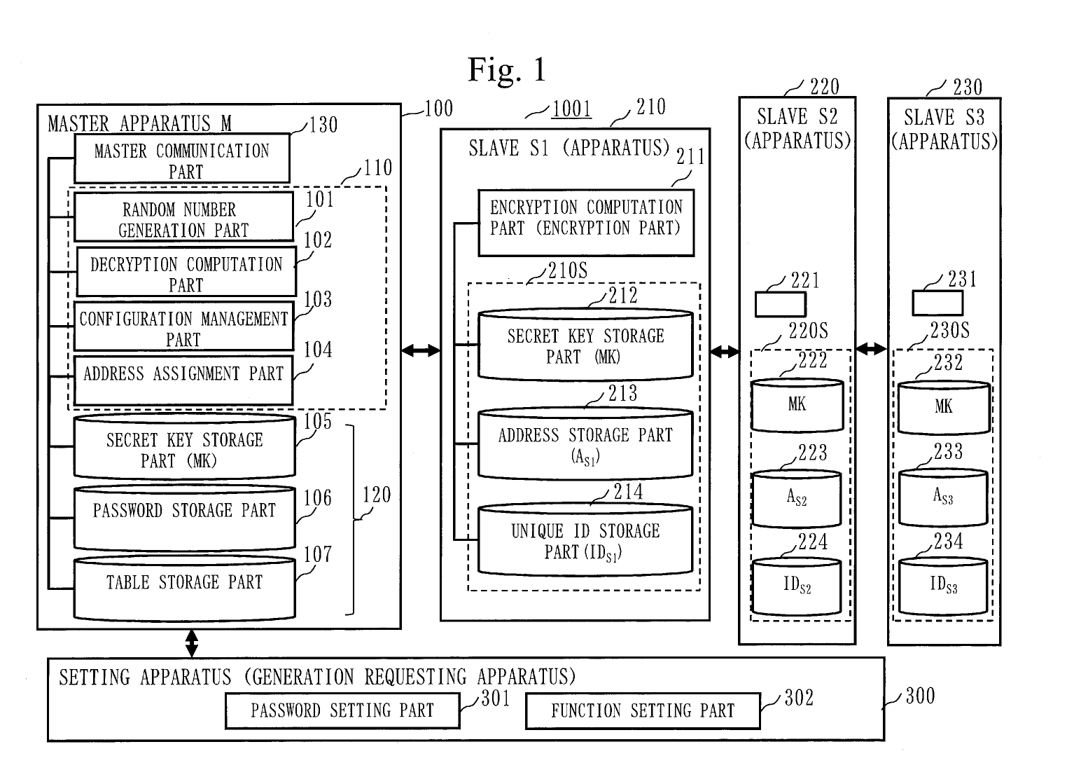

FIG. 1 is a configuration diagram of a component authentication system 1001 (communication system) according to a first embodiment. The component authentication system 1001 according to the first embodiment is composed of one master apparatus 100 and three slave devices 210, 220, and 230. Note that the number of slave devices (three) is an example. The number of slave devices may be two, and may also be four or more. A setting apparatus 300 (generation requesting apparatus) is an apparatus that performs initial setting to the master apparatus 100. In FIG. 1, the slave devices 210, 220, and 230 are indicated as the slave devices S1, S2, and S3, respectively. The slave devices 210, 220, and 230 will hereinafter be referred to as the slave devices S1, S2, and S3, respectively. The salve devices S1, S2, and S3 have substantially the same configuration, and an address to be stored and a unique ID are different for each slave device, as will be described later.

The master apparatus 100 includes a master control part 110, a master storage part 120, and a master communication part 130. The master control part 110 includes a random number generation part 101, a decryption computation part 102, a configuration management part 103, and an address assignment part 104. The master storage part 120 includes a secret key storage part 105, a password storage part 106, and a table storage part 107. The master communication part 130 has an interface function to connect and communicate with each slave device and an interface function to connect and communicate with the setting apparatus 300.

The function of each composing element will be described.
(1) The random number generation part 101 generates a random number required for an authentication protocol.
(2) The decryption computation part 102 performs decryption computation required for the authentication protocol.
(3) The configuration management part 103 manages a configuration of slave devices being allowed to be connected.
(4) The address assignment part 104 assigns an address for communication to each slave device.
(5) The secret key storage part 105 stores a secret key MK (second secret information) required for the authentication protocol.
(6) The password storage part 106 stores information related to a password for access control for changing the setting of the master apparatus 100.
(7) The table storage part 107 stores the configuration of slave devices being allowed to be connected, as a setting phase correspondence table 107a (to be described later) associating an address (initial address to be described later) with an identifier.

Note that it is assumed that each storage part described as a “ . . . storage part” has a property called “tamper resistance” which prevents information from being read or rewritten from outside, except for through legitimate access.

The slave device S1 has a communication interface (not illustrated) to communicate with the master apparatus 100 and the other slave devices by daisy chain connection. As illustrated in FIG. 1, the slave device S1 includes an encryption computation part 211 (encryption part) and a storage part 210S. The storage part 210S includes a secret key storage part 212, an address storage part 213, and a unique ID storage part 214.
(1) The encryption computation part 211 performs encryption computation required for the authentication protocol.
(2) The secret key storage part 212 stores a secret key MK (first secret information) required for the authentication protocol. The secret key MK is a bit string that is identical to the secret key MK stored in the secret key storage part 105 of the master apparatus 100. Note that the secret key of each slave device is not required to be identical to the secret key of the master apparatus 100, provided that data encrypted by the secret key (secret information) of each slave device can be decrypted by the secret key (secret information) of the master apparatus 100.
(3) The address storage part 213 stores an address for communication that is assigned by the master apparatus 100. The address assigned to the slave device S1 will be represented as A_{S1}.
(4) The unique ID storage part 214 stores an ID (identifier) which is unique to each slave device. The ID (to be hereinafter referred to as a unique ID) of a slave device is assigned in advance by a manufacturer when the slave device is manufactured. The unique ID of the slave device S1 will be represented as ID_{S1}.

The slave device S2 has substantially the same functions and configuration as those of the slave device S1. The slave device S2 includes an encryption computation part 221, a secret key storage part 222, an address storage part 223, and a unique ID storage part 224. However, the unique ID and the address that is assigned by the master apparatus 100 are different for the slave device S2. These will be represented as ID_{S2} and A_{S2}, respectively.

The slave device S3 also has substantially the same functions and configuration as those of the slave device S1. The slave device S3 includes an encryption computation part 231, a secret key storage part 232, an address storage part 233, and a unique ID storage part 234. The unique ID and the address that is assigned by the master apparatus 100 are different for the slave device S3. These will be represented as ID_{S3} and A_{S3}, respectively.

The setting apparatus 300 is, for example, an ordinary personal computer and has a communication interface (not illustrated) to communicate with the master apparatus 100. This communication interface is, for example, USB, a LAN (Local Area Network), or the like. The setting apparatus 300 includes a password setting part 301 to set a password to the master apparatus 100 and a function setting part 302 to set a function to the master apparatus 100.

The operation of the component authentication system 1001 will now be described. The operation includes two phases, which are a setting phase (PH1) and a communication phase (PH2).

In the setting phase (PH1), information on the correct configuration of the slave devices (the setting phase correspondence table 107a) is stored in the master apparatus 100 with the setting apparatus 300.

In the communication phase (PH2), the master apparatus 100 checks if the configuration of the setting phase (PH1) is maintained.

An address is assigned in each of the setting phase (PH1) and the communication phase (PH2). An address assigned in the setting phase (PH1) will also be referred to as an initial address, and an address assigned in the communication phase (PH2) will also be referred to as a communication start address.

In order to perform processing of the setting phase (PH1) and the communication phase (PH2), the secret key MK of the master apparatus 100 is shared by the slave devices. In addition, the unique ID of each slave device, instead of the ID of the master apparatus 100, is used for the authentication protocol.

In the setting phase (PH1), at the start of communication in the daisy chain, the master apparatus 100 assigns an address (initial address to be described later) to each slave device sequentially starting with the slave device nearest to the master apparatus 100, and generates and holds the setting phase correspondence table 107a (correspondence information) associating this address and the unique ID of each slave device. In this way, the slave devices are connected at respective connection positions that determine an address order. That is, in the case of FIG. 1, the connection position of the slave device S1 is a first position in the address order, the connection position of the slave device S2 is a second position in the address order, and the connection position of the slave device S3 is a third position in the address order. When the setting phase correspondence table 107a is generated, a password is registered in the master apparatus 100 through the setting apparatus 300. Thereafter, when the setting phase correspondence table 107a is to be updated or deleted, password authentication is performed. Note that the setting phase correspondence table 107a herein manages a pair of an address and an ID.

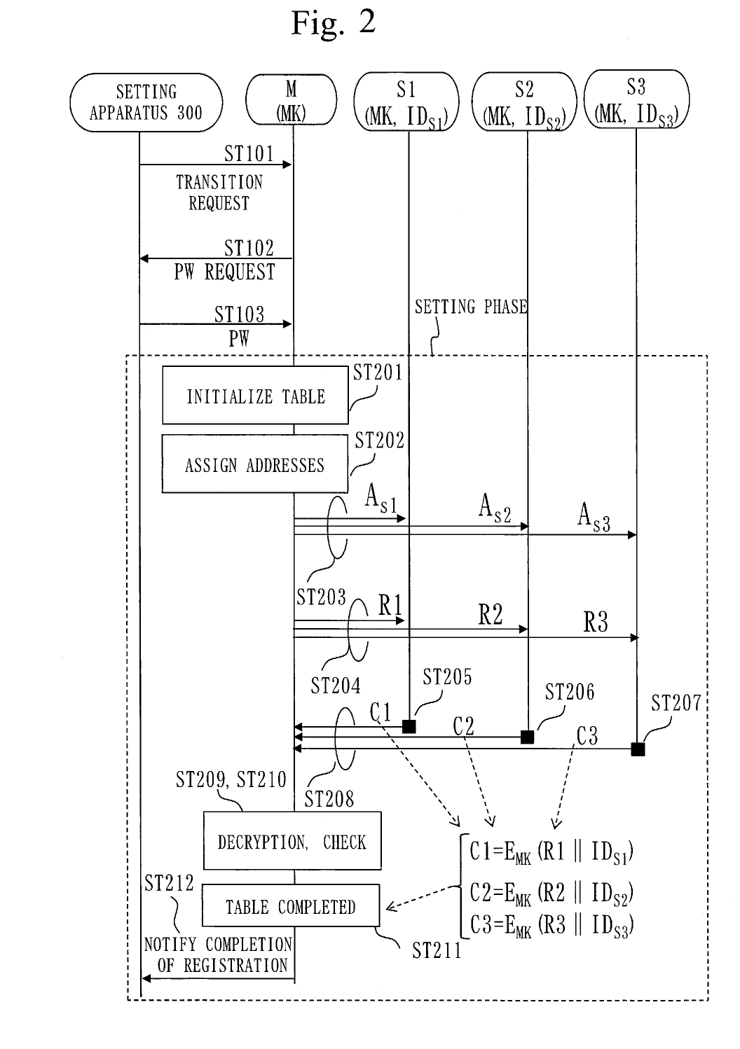

FIG. 2 is a sequence of the setting phase (PH1) of the component authentication system 1001. With reference to FIG. 2, the setting phase (PH1) will be described. In FIG. 2, the master apparatus 100 is indicated as “M”, and the slave devices S1 to S3 are indicated as “S1 to S3”, respectively.
(1) The password setting part 301 of the setting apparatus 300 transmits a transition request for transition to the setting phase (PH1) to the master apparatus 100 (ST101). When the master communication part 130 receives the transition request, the configuration management part 103 requests, through the master communication part 130, a password check from the setting apparatus 300 (ST102). If a proper password is transmitted from the password setting part 301, the configuration management part 103 of the master apparatus 100 makes a transition to the setting phase (PH1) (ST103). If a proper password is not confirmed, the processing terminates. Note that the configuration management part 103 refers to the password storage part 106, and if in an initial state in which no password is set, the configuration management part 103 performs the initial setting of a password as a priority before making a transition to the setting phase (PH1).
(2) When the transition is made to the setting phase (PH1), the configuration management part 103 initializes the table storage part 107 (ST201), and an address for communication is assigned to each slave device by the address assignment part 104 (ST202). The master communication part 130 transmits each address (initial address) assigned by the address assignment part 104 to each slave device (ST203). These addresses are Aₛ₁ Aₛ₂, and Aₛ₃, as stated in the description of FIG. 1.
(3) In the master apparatus 100, the random number generation part 101 generates a random number R1 (first identifier request), and the configuration management part 103 transmits the random number R1 to the slave device S1 with the master communication part 130.
(4) Similarly, the master apparatus 100 transmits a random number R2 (first identifier request) to the slave device S2, and transmits a random number R3 (first identifier request) to the slave device S3 (ST204). Note that in order to simplify the processing it may be arranged such that R1=R2=R3 and the random numbers may be notified simultaneously.
(5) When the slave device S1 receives the random number R1, the encryption computation part 211 computes encrypted data C1 (encrypted identifier) below using the secret key MK in the secret key storage part 212 (ST205).

C1=E_{MK}(R1∥ID_{S1})
(6) Similarly, the slave device S2 and the slave device S3 also compute encrypted data C2 (encrypted identifier) and encrypted data C3 (encrypted identifier) below, respectively (ST206, ST207).

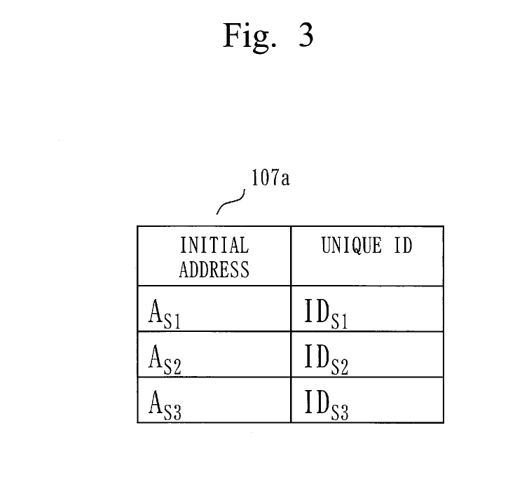

C2=E_{MK}(R2∥ID_{S2}), C3=E_{MK}(R3∥ID_{S3})
(7) In the master apparatus 100, after the computation of C1 to C3 by the respective slave devices is completed, the configuration management part 103 retrieves the encrypted data C1 to C3 being computation results from the respective slave devices (ST208). That is, the master apparatus 100 holds (obtains) C1, C2, and C3.
(8) The decryption computation part 102 decrypts the encrypted data C1 using the secret key MK in the secret key storage part 105 (ST209). Then, the configuration management part 103 checks if the transmitted random number R1 coincides with a part of a decryption result of the encrypted data C1 (ST210). If coincidence occurs, the configuration management part 103 registers the rest of the decryption result (a portion of the decryption result that excludes the random number), namely ID_{S1}, in the setting phase correspondence table 107a in the table storage part 107 as a pair with the address A_{S1}. If the transmitted random number R1 does not coincide with a part of the decryption result of the encrypted data C1, the configuration management part 103 outputs (notifies) non-coincidence (the possibility that the slave device S1 may be a counterfeit product), and terminates the processing on the encrypted data C1 of the slave device S1. This notification of the possibility of a counterfeit product may be transmitted to the setting apparatus 300, or may be displayed on a display device (not illustrated) included in the master apparatus 100.
(9) The master apparatus 100 executes substantially the same processing (ST209, ST210) on the encrypted data C2 and C3, and checks if the transmitted random numbers R2 and R3 coincide with a part of a decryption result of the encrypted data C2 and C3, respectively. That is, with regard to the encrypted data C2, if a part of the decryption result of the encrypted data C2 does not coincide with the transmitted random number R2, the configuration management part 103 notifies the possibility that the slave device S2 may be a counterfeit product and terminates the processing on the encrypted data C2, as in the case of the slave device S1. If coincidence occurs, the configuration management part 103 registers a pair of the ID (a portion of the decryption result that excludes the random number) and the address Aₛ₂ in the setting phase correspondence table 107a in the table storage part 107. With regard to the encrypted data C3, the processing is also the same as that on the encrypted data C2.
(10) If the authentication process is completed normally for all of the slave devices S1 to S3 to which addresses have been assigned, the setting phase correspondence table 107a illustrated in FIG. 3 is completed (ST211).

FIG. 3 is the setting phase correspondence table 107a that is generated by the configuration management part 103 if all of the slave devices S1 to S3 are authentic devices. The configuration management part 103 notifies the setting apparatus 300 of completion of registration of the pairs of the IDs (a portion of the decryption result that excludes the random number) and the addresses in the setting phase correspondence table 107a in the table storage part 107 (ST212).

Note that the setting for the master apparatus 100 and each slave device to operate in an expected manner as each device is to be separately performed through the setting apparatus 300 using the function setting part 302. As an example of this setting, “to install a ladder program on a PLC from a dedicated tool of a personal computer being the setting apparatus 300” may be pointed out.

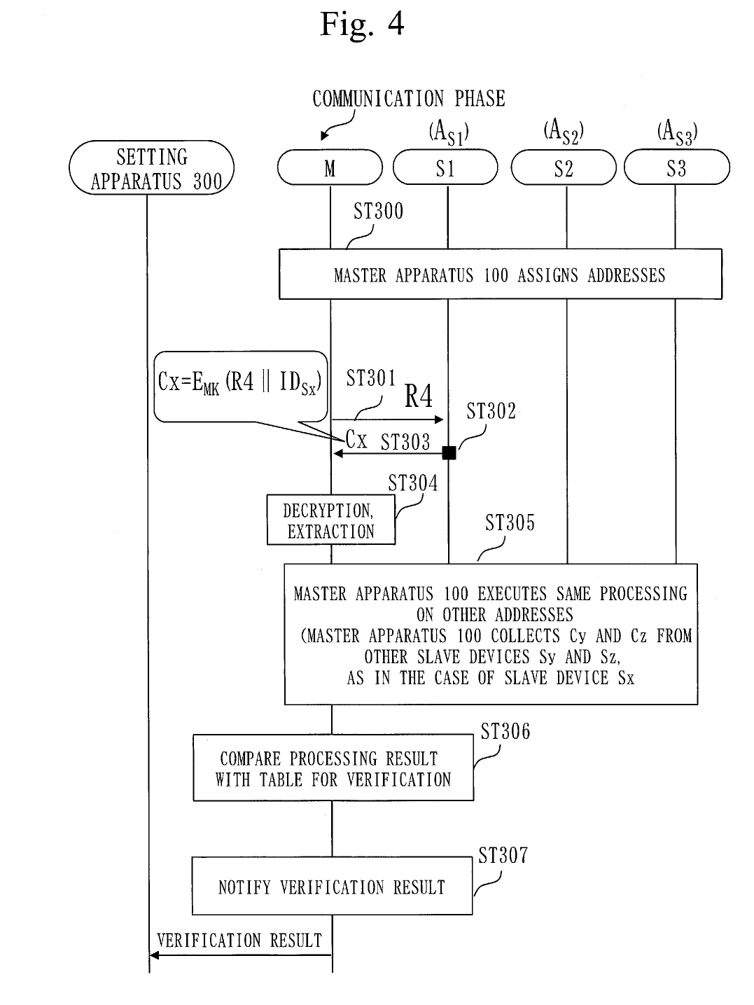

Next, with reference to FIG. 4, the communication phase (PH2) will be described.

FIG. 4 is a sequence of the communication phase (PH2) of the component authentication system 1001. The authentication in the communication phase (PH2) is performed with the following procedure at power-on of the system and so on. At the start of communication with the slave devices, that is, at the start of the communication phase (PH2), the master apparatus 100 assigns addresses for communication again (ST300). The method for assigning addresses is the same as in the setting phase (PH1). That is, also in the communication phase (PH2), the address assignment part 104 assigns addresses A_{S1}, A_{S2}, and A_{S3} sequentially starting with the slave device nearest to the master apparatus 100 in the daisy chain. The addresses assigned in the communication phase (PH2) are communication start addresses.
(1) In the master apparatus 100, the random number generation part 101 generates a random number R4 (second identifier request), and the master communication part 130 transmits the random number R4 to the slave device having the address A_{S1} (ST301). In this case, the address A_{S1} belongs to the slave device nearest to the master apparatus 100 as in the setting phase (PH1). However, the slave device having the address A_{S1} is not limited to the slave device S1. The slave device having the address A_{S1} will be described as a slave device Sx, and its unique ID will be described as ID_{Sx}.

Similarly, the slave device having the address A_{S2} and the slave device having the address A_{S3} will be described as a slave device Sy and a slave device Sz, respectively, and their unique IDs will be described as ID_{Sy} and ID_{Sz}, respectively.
(2) The slave device Sx having the address A_{S1} computes encrypted data Cx (encrypted identifier) below using the unique ID_{Sx}, the received random number R4, and the secret key MK (ST302).

Cx=E_{MK}(R4∥ID_{Sx})

The configuration management part 103 of the master apparatus 100 retrieves and obtains the encrypted data Cx through the master communication part 130 (ST303).
(3) In the master apparatus 100, the decryption computation part 102 decrypts the obtained encrypted data Cx and extracts the random number R4 and ID_{SX} (ST304).
(4) Similarly, the processing of (1) to (3) above (ST301 to ST304) is executed on communication start addresses (in this case, A_{S2} and A_{S3}) that are the same as the initial addresses that have been assigned in the setting phase (PH1) (ST305). Note that the master apparatus 100 transmits a random number R5 (second identifier request) and a random number R6 (second identifier request) to the slave devices Sy and Sz having the addresses A_{S2} and A_{S3}, respectively, and obtains encrypted data Cy and Cz (encrypted identifier).
(5) The configuration management part 103 checks if all of the random numbers R4 to R6 have been decrypted correctly. If all of the random numbers R4 to R6 have been decrypted correctly, the configuration management part 103 checks and verifies whether the pairs of the initial addresses and the IDs registered in the setting phase correspondence table 107a of the setting phase (PH1) coincide with the pairs of the communication start addresses and the IDs decrypted and obtained in the communication phase (PH2) (ST306). Note that checking if each random number has been decrypted correctly and obtaining the unique ID if the random number has been decrypted correctly are the same processing as in the setting phase (PH1).

In the verification process in ST306, the configuration management part 103 determines a verification pass if each “pair of the initial address and the ID” in the setting phase correspondence table 107a coincides with a corresponding “pair of the communication start address and the ID”, determines a verification failure if incorrect, and notifies the setting apparatus 300 of a result of determination through the master communication part 130 (ST307). Note that a verification pass is a case where the pairs of the communication start addresses and the IDs that have been obtained are “A_{S1}, ID_{Sx}=ID_{S1}” and “A_{S2}, ID_{Sy}=ID_{S2}” and “A_{S3}, ID_{Sz}=ID_{S3}” in relation to the setting phase correspondence table 107a illustrated in FIG. 3.

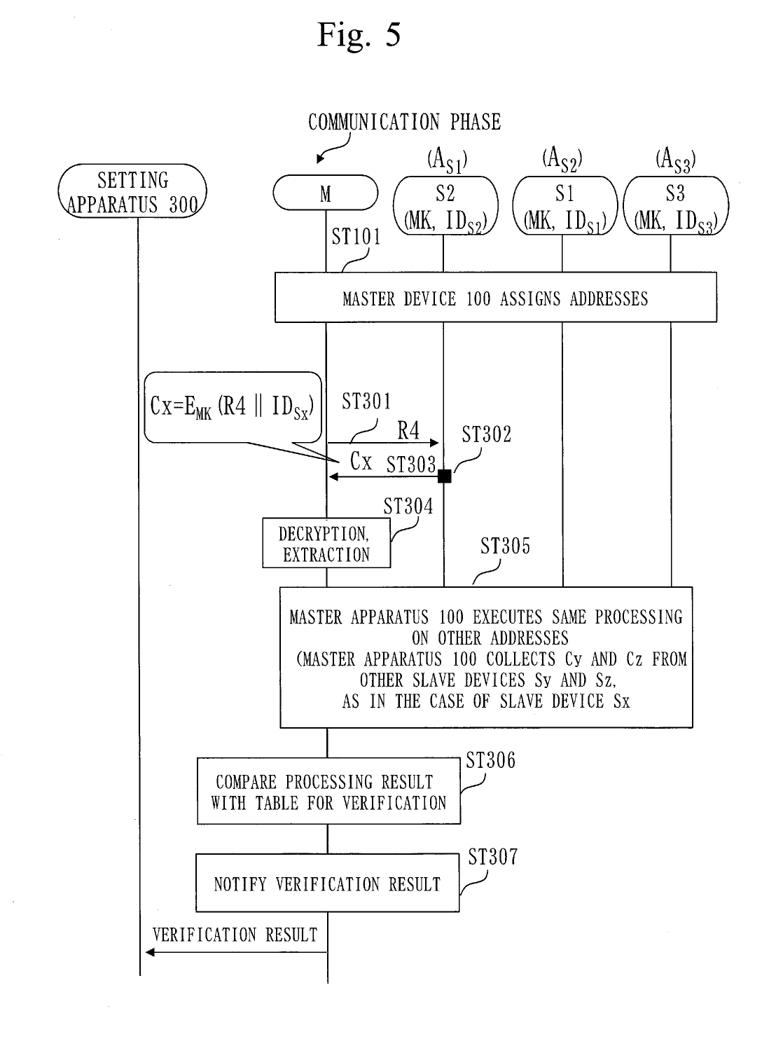

FIG. 5 is a sequence of an example where the verification process (ST306) in the communication phase (PH2) results in a verification failure. FIG. 5 differs from FIG. 4 in the order of the slave device S1 and the slave device S2, and is the same as FIG. 4 in other respects.

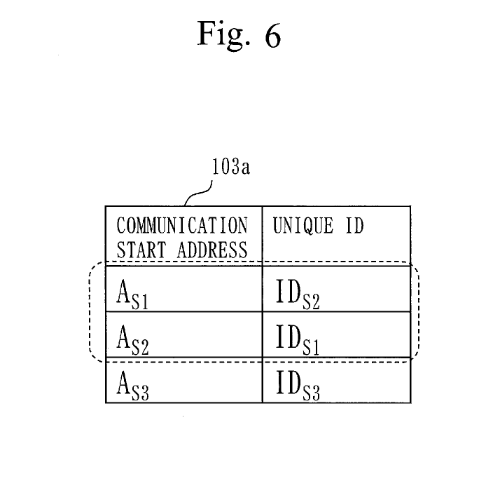

FIG. 6 is the communication phase correspondence table 103a indicating pairs of the communication start addresses and the IDs obtained in the case of FIG. 5. In FIG. 6, the unique IDs of the addresses A_{S1} and A_{S2} are interchanged with each other, compared with the setting phase correspondence table 107a of FIG. 3. This is because the master apparatus 100 assigns communication start addresses sequentially starting with the nearest slave device, so that A_{S1} is assigned to the slave device S2 and A_{S2} is assigned to the slave device S1. Therefore, the configuration management part 103 determines a verification failure in ST306.

In the component authentication system 1001 according to the first embodiment, the unique ID of each slave device is used for the encrypted data C to be used for authentication. Thus, if the slave device near the master apparatus is a fraudulent product, it is possible to prevent the fraudulent slave device from making an authentic slave device at a later position calculate a response (encrypted data C) and returning a result thereof to the master apparatus to be successfully authenticated.

If all of the slave devices are authentic products, the configuration including the order can be recognized, as described with reference to FIG. 5 and FIG. 6.

### Second Embodiment

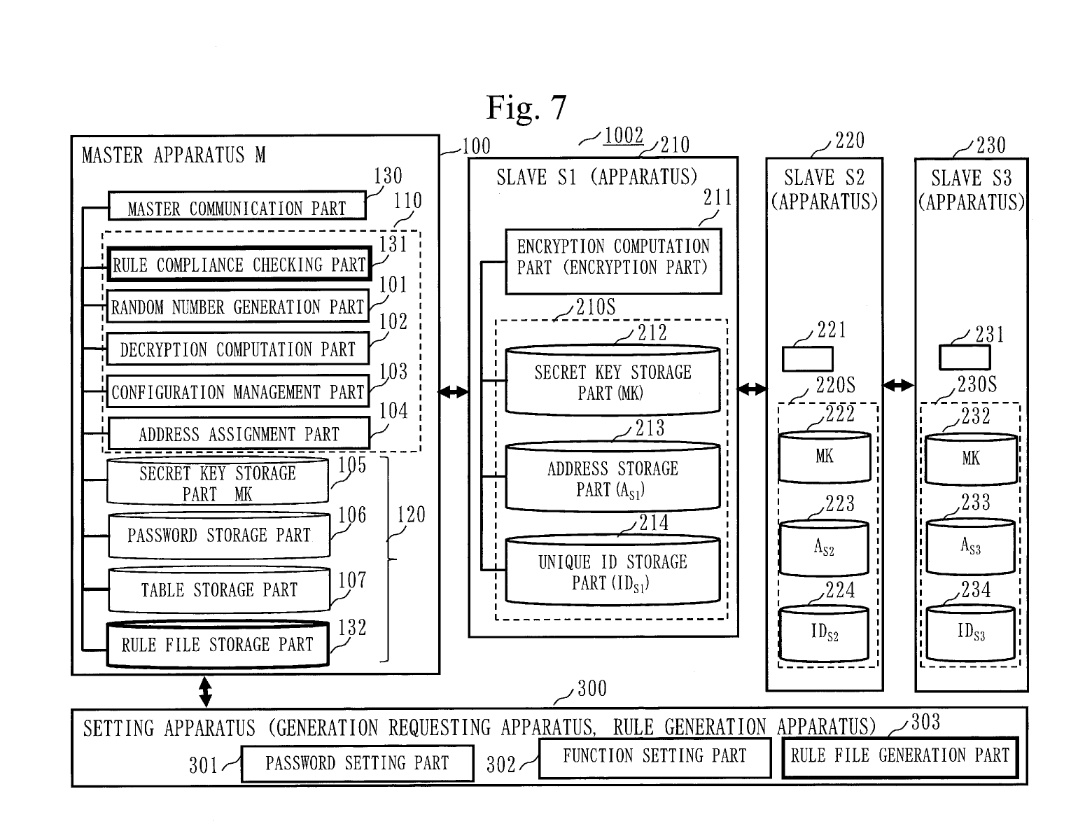

With reference to FIG. 7 to FIG. 12, a component authentication system 1002 according to a second embodiment will be described.

The first embodiment requires a one-to-one correspondence between the system configuration stored in the setting phase (PH1) and the system configuration in the communication phase (PH2). That is, the condition for a verification pass in the authentication process (ST306) is that the content of the setting phase correspondence table 107a of FIG. 3 coincides with the content of the communication phase correspondence table 103a of FIG. 6. If the addresses in the setting phase correspondence table 107a are the same as those in the communication phase correspondence table 103a, the corresponding IDs are required to coincide with each other.

More specifically, in the case of the first embodiment, it is required that the slaves S1, S2, and S3 are connected in this order starting with the one nearest to the master apparatus 100. The configuration in which the slaves S2, S1, and S3 are connected in this order starting with the one nearest to the master apparatus 100, as illustrated in FIG. 5, results in a verification failure in the authentication process (ST306). This means that in the first embodiment once the system configuration has been set, this setting cannot be changed by a person other than those authorized. In the first embodiment, therefore, use of the functions described in the first embodiment is limited to security use, detection of an order inconsistency, and so on.

In light of this, functions are added to the first embodiment such that it is possible with the configuration according to the second embodiment to notify a user, when the system is changed, that the system configuration is not a recommended configuration due to a problem in electrical characteristics, performance, or compatibility, and so on of a slave device.

FIG. 7 is a configuration diagram of the component authentication system 1002 according to the second embodiment. In terms of the configuration, the component authentication system 1002 differs from the component authentication system 1001 in the following points.
(1) The master apparatus 100 includes a rule compliance checking part 131 and a rule file storage part 132 (master file storage part).
(2) The setting apparatus 300 (rule generation apparatus) includes a rule file generation part 303.

Except for the above (1) and (2), the configuration of the component authentication system 1002 is the same as that of the component authentication system 1001.

The rule file storage part 132 stores two types of files, which are a rule file Lv1 and a rule file Lv2.
(1) The rule file Lv1 is a file in which rules set by a manufacturer A that manufactures a device body, such as a master apparatus or a slave device, are described.
(2) The rule file Lv2 is a file in which rules for configuring a system that combines a master apparatus and slave devices (the component authentication system 1001, the component authentication system 1002, or a system similar to these systems) are described. The rule file Lv2 is set by a manufacturer B that uses the above-described system.

The rule file Lv1 defines restrictions, such as the maximum number of connections of the master apparatus, a combination of slave devices according to types, and the number of connected slave devices, as rules in a list format. The rule file Lv1 is stored in the rule file storage part 132 by the manufacturer A that manufactures the master apparatus 100 when the master apparatus 100 is manufactured.

The rule file Lv2 defines restrictions specified by the manufacturer B that uses the above-described system in a list format. For example, the rule file Lv2 defines the number of slave devices allowed for expansion, a type and a range of a slave device allowed to be exchanged, and so on.

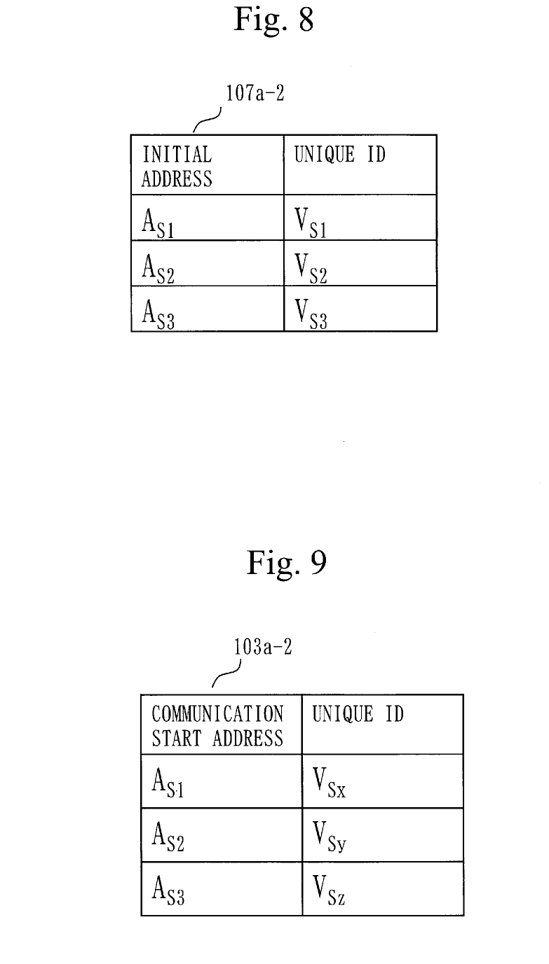

The rule file Lv2 is set in the rule file storage part 132 by the rule file generation part 303 of the setting apparatus 300 in the setting phase (PH1), as in the case of a setting phase correspondence table 107a-2 to be described later with reference to FIG. 8. To set or change the rule file Lv2, password authentication is performed between the setting apparatus 300 and the master apparatus 100. Note that in principle the rule file Lv1 is not to be changed by the setting apparatus 300 (manufacturer B), but this is not limiting. Like the rule file Lv2, the rule file Lv1 may be allowed to be set or changed by the setting apparatus 300 (manufacturer B).

The authentication in the communication phase (PH2) according to the second embodiment is performed with the following procedure. The authentication in the setting phase (PH1) according to the second embodiment is the same as that in the first embodiment, and thus will not be described. Note that in the second embodiment the unique ID of a slave device will be represented as “V”. For example, the unique ID of the slave device S1 will be represented as V_{S1}.

FIG. 8 illustrates the setting phase correspondence table 107a-2 generated in the setting phase (PH1) according to the second embodiment.

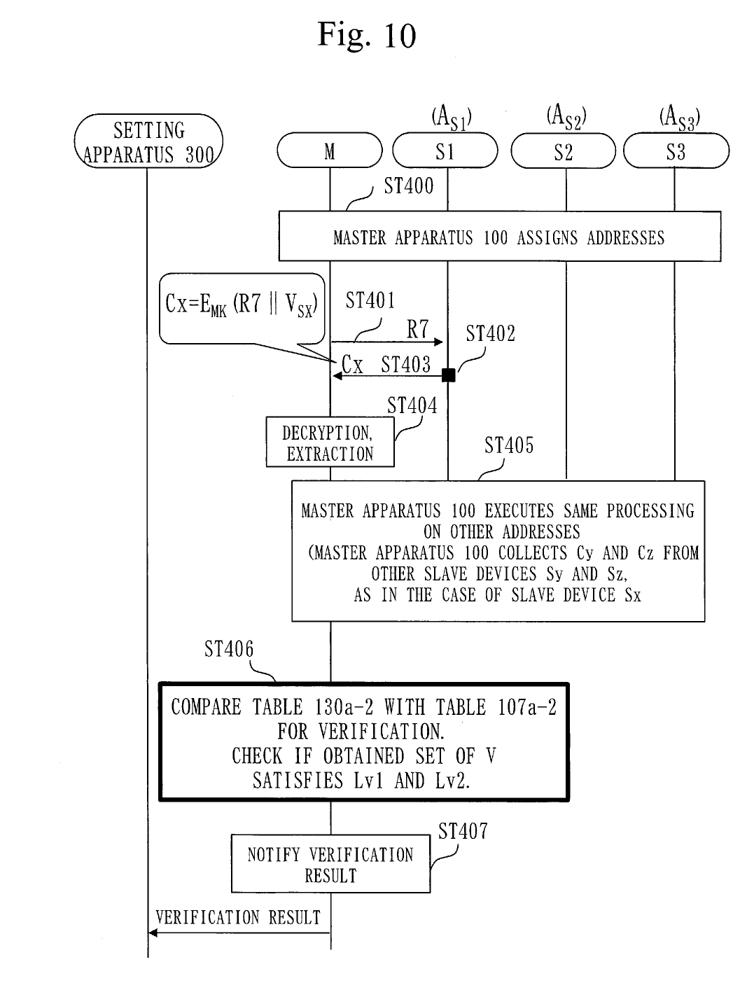

FIG. 9 illustrates a communication phase correspondence table 103a-2 to be generated in the communication phase (PH2) of FIG. 10.

FIG. 10 is a sequence of the communication phase (PH2) according to the second embodiment. With reference to FIG. 8 to FIG. 10, the communication phase (PH2) according to the second embodiment will be described. As illustrated in FIG. 10, the master apparatus 100 assigns addresses for communication again at the start of the communication phase (PH2), as in the case of the first embodiment (ST400).

The communication phase (PH2) according to the second embodiment differs from the first embodiment in the content of processing in ST406. In ST406, the configuration management part 103 compares the setting phase correspondence table 107a-2 (FIG. 8) with the communication phase correspondence table 103a-2 (FIG. 9). In the first embodiment, a verification pass is determined if the content of the setting phase correspondence table 107a coincides with the content of the communication phase correspondence table 103a. In contrast, in the second embodiment, a verification pass is determined finally depending on whether or not the set of unique IDs obtained in the communication phase (PH2) conforms to the rule file Lv1 and the rule file Lv2. The communication phase (PH2) will be described below.

The slave devices having the addresses A_{S1} to A_{S3} in the communication phase will be described as the slave devices Sx to Sy, respectively. At the start of communication, the master apparatus 100 does not know the correspondence between the slave devices Sx to Sy and the slave devices S1 to S3. In FIG. 10, the slave devices Sx to Sy correspond to the slave device S1 to S3, respectively.
(1) The master apparatus 100 transmits a random number R7 to the slave device Sx having the address A_{S1} (ST401).
(2) The slave device Sx generates encrypted data Cx below using the received random number R7, V_{Sx} including a model number and/or version information as the unique ID, and the secret key MK (ST402).

Cx=E_{MK}(R7∥V_{Sx})

The configuration management part 103 of the master apparatus 100 retrieves the encrypted data Cx from the slave device Sx through the master communication part 130 (ST403).
(3) The master apparatus 100 decrypts the encrypted data Cx by the secret key MK and extracts R7 and V_{Sx} (ST404).
(4) Similarly, the processing of (1) to (3) above (ST401 to ST404) is executed on the addresses A_{S2} and A_{S3} that have been assigned in the setting phase (PH1) (ST405).

It is assumed that random numbers R8 and R9 are transmitted to the addresses A_{S2} and A_{S3}, respectively.

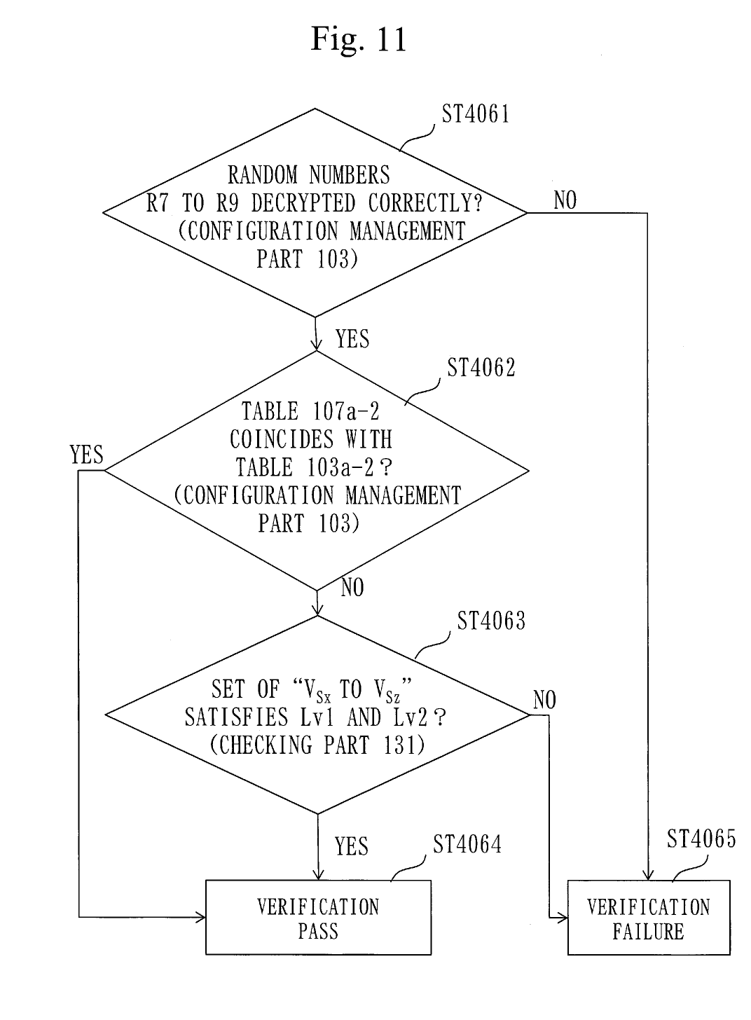

FIG. 11 is a flowchart illustrating details of ST406. With reference to FIG. 11, ST406 will be described. In FIG. 11, a description such as (the configuration management part 103) indicates a composing element that performs determination processing.
(5) The configuration management part 103 checks if all of the random numbers R7 to R9 have been decrypted correctly (ST4061). That the random numbers R7 to R9 have been decrypted correctly means that the unique ID column in the communication phase correspondence table 103a-2 of FIG. 9 is completely filled. If not decrypted correctly, a verification failure is determined (ST4065). If the random numbers R7 to R9 have been decrypted correctly, the configuration management part 103 checks if the content of the setting phase correspondence table 107a-2 (FIG. 8) coincides with the content of the communication phase correspondence table 103a-2 (FIG. 9) (ST4062). If coincidence occurs, the configuration management part 103 determines a verification pass (ST4064).

If the content of the setting phase correspondence table 107a-2 does not coincide with the content of the communication phase correspondence table 103a-2, the processing proceeds to ST4063. In ST4063, the rule compliance checking part 131 checks if the set of V's (“V_{Sx}, V_{Sy}, and V_{Sz}” in this example) obtained in FIG. 9 conforms to the rule file Lv1 and the rule file Lv2. The rule compliance checking part 131 determines a verification pass if the set of V's conforms to the rule files Lv1 and Lv2 (ST4064), and determines a verification failure if not (ST4065), and notifies the setting apparatus 300 of a result of determination (ST407).

The second embodiment is characterized in that, instead of assigning a simple non-overlapping bit string to the unique ID “V”, a number system that allows a model number and/or version information to be identified is incorporated in “V”, and this “V” constituting the number system is used for a rule.

In FIG. 11, a check is made in ST4062 as to whether or not the content of the setting phase correspondence table 107a-2 coincides with the content of the communication phase correspondence table 103a-2. However, the processing in ST4062 may be omitted.

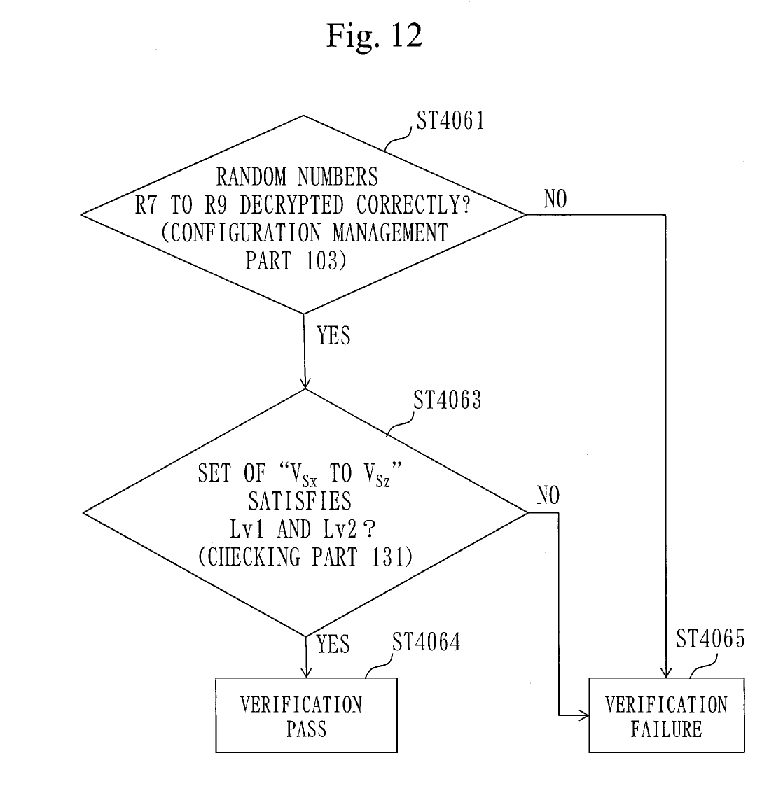

FIG. 12 is a flowchart in which ST4062 is omitted. In the case of FIG. 12, if the random numbers have been decrypted correctly, that is, if the set of V's “V_{Sx}, V_{Sy}, and V_{Sz}” has been obtained, a check is made as to whether or not the set of V's conforms to the rule file Lv1 and the rule file Lv2 without performing the processing in ST4062.

In the second embodiment, the rule file Lv1 and the rule file Lv2 are used. Thus, it is possible with the rule file Lv1 and the rule file Lv2 to prescribe restrictions regarding connection of slave devices, such as a connection order, the maximum number of other slave devices allowed to be connected to each slave device, and a combination of slave devices that cannot be used simultaneously. This allows verification of a connection configuration which does not satisfy these regulations.

In the second embodiment, if the random numbers have been decrypted correctly, it is not required that the set of V's in the setting phase correspondence table 107a-2 completely coincide with the set of V's in the communication phase correspondence table 103a-2, as illustrated in FIG. 12. Thus, the system configuration can be verified flexibly.

Note that in the second embodiment the rule file Lv1 and the rule file Lv2 are used, but this is an example. It is understood that the rule file Lv1 and the rule file Lv2 may be combined into a single rule file, or three or more rule files may be used.

In the second embodiment, a determination is made as to whether or not the set of V's being the unique IDs conforms to the rule file Lv1 and the rule file Lv2. When a plurality of unique IDs is regarded as a group, a determination is made as to whether or not this group satisfies the rule files Lv1 and Lv2. This is not limiting, and a determination may be made as to whether or not individual unique IDs of the plurality of unique IDs satisfy the rule files Lv1 and Lv2.

In the second embodiment, the same number of slave devices, three slave devices, are connected in both the setting phase and the communication phase. However, this is an example, and it is understood that the number of slave devices to be connected may be different between the setting phase and the communication phase. If the number of slave devices to be connected is different, a determination of a verification pass in the communication phase depends on the rule file Lv1 or the rule file Lv2.

The first and second embodiments have been described above. These two embodiments may be implemented in combination. Alternatively, one of these embodiments may be partially implemented. Alternatively, these two embodiments may be partially implemented in combination. The present invention is not limited to these embodiments, and various modifications are possible as appropriate.

### Third Embodiment

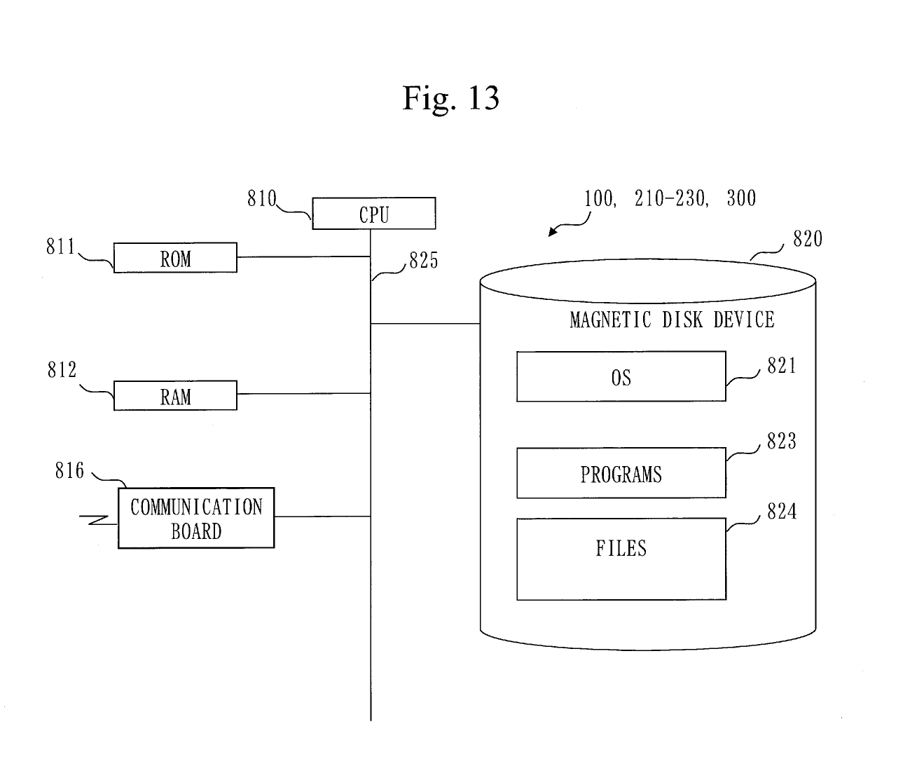

With reference to FIG. 13, a third embodiment will be described. The third embodiment describes the hardware configuration of the master apparatus, the slave device, or the setting apparatus, each being a computer.

FIG. 13 is a diagram illustrating an example of hardware resources of the master apparatus (or the slave device or the setting apparatus).

With reference to FIG. 13, the master apparatus (or the slave device or the setting apparatus) includes a CPU 810 (Central Processing Unit) that executes programs. The CPU 810 is connected with a ROM (Read Only Memory) 811, a RAM (Random Access Memory) 812, a communication board 816, and a magnetic disk device 820 through a bus 825, and controls these hardware devices. The magnetic disk device 820 may be replaced with a storage device such as an optical disk device and a flash memory.

The RAM 812 is an example of a volatile memory. A storage medium such as the ROM 811 and the magnetic disk device 820 is an example of a non-volatile memory. These are examples of a storage device, a storage part, a storing part, and a buffer. The communication board 816 is an example of an input device, and is also an example of an output part and an output device.

The magnetic disk device 820 stores an operating system 821 (OS), programs 823, and files 824. The programs 823 are executed by the CPU 810 and the operating system 821.

The programs 823 store programs for implementing each function described as a “part” in the description of the embodiments above. The programs are read and executed by the CPU 810.

The files 824 store, as items of a “file” or a “database”, information, data, signal values, variable values, parameters, and so on described as a “result of determination”, a “result of calculation”, a “result of extraction”, a “result of generation”, and a “result of processing” in the description of the embodiments above. The “file” and “database” are stored in a recording medium such as a disk or a memory. The information, data, signal values, variable values, and parameters stored in the recording medium such as the disk or the memory are read by the CPU 810 to a main memory or a cache memory through a read/write circuit, and are used for the operation of the CPU such as extraction, search, reference, comparison, computation, calculation, processing, and output. During the operation of the CPU such as extraction, search, reference, comparison, computation, calculation, processing, and output, the information, data, signal values, variable values, and parameters are temporarily stored in the main memory, the cache memory, or a buffer memory.

In the description of the embodiments above, what is described as a “part” may be “means” and may also be a “step”, a “procedure”, or a “process”. That is, what is described as a “part” may be implemented only by software, or by a combination of software and hardware, or further by a combination including firmware. The programs are read by the CPU 810 and are executed by the CPU 810. The programs cause a computer to function as the “parts” described above. Alternatively, the programs cause the computer to execute a procedure or a method of the “parts” described above.

In the above embodiments, the master apparatus, the slave device, the setting apparatus, and so on have been described. It is understood that the master apparatus, the slave device, the setting apparatus, and so on may be interpreted as programs for causing to function as the master apparatus, the slave device, the setting apparatus, and so on.

It is apparent from the description above that the operation of each “part” of the master apparatus, the slave device, the setting apparatus, and so on may be interpreted also as a method.

### REFERENCE SIGNS LIST

100: master apparatus, 101: random number generation part, 102: decryption computation part, 103: configuration management part, 103a, 103a-2: communication phase correspondence table, 104: address assignment part, 105: secret key storage part, 106: password storage part, 107: table storage part 107a,107a-2: setting phase correspondence table, 110: master control part, 120S: master storage part, 130: master communication part, 131: rule compliance checking part, 132: rule file storage part, 210, 220, 230: slave device, 210S, 220S, 230S: storage part, 211, 221, 231: encryption computation part, 212, 222, 232: secret key storage part, 213, 223, 233: address storage part, 214, 224, 234: unique ID storage part, 300: setting apparatus, 301: password setting part, 302: function setting part, 303: rule file generation part, 1001, 1002: component authentication system

1. A communication system comprising:
a master apparatus; and
a plurality of apparatuses, each being connected at each connection position which determines an address order and performing communication with the master apparatus,
each apparatus of the plurality of apparatuses including:
memory to store an identifier and first secret information; and
an encryptor to encrypt the identifier by the first secret information,
the master apparatus including:
a master memory to store second secret information;
a master communicator to perform communication with each apparatus; and
a master controller to assign, to each apparatus, an address in accordance with the address order and to be used for the communication, as an initial address, and using the initial address, transmit a first identifier request for requesting an identifier to each apparatus from the master communicator,
the encryptor of each apparatus, when the first identifier request is received, encrypting the identifier by the first secret information to generate an encrypted identifier,
the master controller obtaining the encrypted identifier from each apparatus with the master communicator, decrypting the obtained encrypted identifier by the second secret information, and generating correspondence information which indicates a correspondence between the decrypted identifier and the initial address used to obtain the decrypted identifier.

2. The communication system according to claim 1,
wherein when starting the communication again through the master communicator after creating the correspondence information, the master controller assigns the address to each apparatus as a communication start address, and using the communication start address, transmits a second identifier request for requesting the identifier again to each apparatus from the master communicator,
wherein when the second identifier request is received, the encryptor of each apparatus encrypts the identifier by the first secret information to generate an encrypted identifier, and
wherein the master controller obtains the encrypted identifier, which has been generated as a result of receiving the second identifier request, from each apparatus with the master communicator, decrypts the obtained encrypted identifier by the second secret information, and checks whether or not a pair of the decrypted identifier and the communication start address used to obtain the decrypted identifier exists in the correspondence information.

3. The communication system according to claim 2,
wherein each apparatus has an attribute of the apparatus as the identifier,
wherein the master apparatus further includes a master rule file memory to store a rule file which describes a rule to be satisfied by the attribute, and
wherein after obtaining the encrypted identifier, which has been generated as a result of receiving the second identifier request, from each apparatus with the master communicator, the master controller determines whether or not the decrypted identifier conforms to the rule in the rule file.

4. The communication system according to claim 3,
wherein after obtaining the encrypted identifier, which has been generated as a result of receiving the second identifier request, from each apparatus with the master communicator, the master controller determines whether or not an identifier group consisting of the decrypted identifier of each apparatus conforms to the rule in the rule file.

5. The communication system according to claim 3, further comprising
a rule generation apparatus having a rule file generator to generate the rule file,
wherein the master rule file memory stores the rule file generated by the rule file generator.

6. The communication system according to claim 5, wherein the rule file generator of the rule generation apparatus changes the rule file stored in the master rule file memory.

7. The communication system according to claim 3,
wherein the identifier includes, as the attribute, at least one of a model number and a version of the apparatus, and
wherein the rule file includes, as the rule, at least one of an electrical characteristic rule of each apparatus, a performance rule of each apparatus, and a compatibility rule of each apparatus.

8. The communication system according to claim 1, further comprising
a generation requesting apparatus to request generation of the correspondence information,
wherein when the generation of the correspondence information is requested by the generation requesting apparatus, the master controller assigns the initial address to each apparatus, transmits the first identifier request to each apparatus using the initial address, obtains the encrypted identifier from each apparatus, and generates the correspondence information.

9. The communication system according to claim 8,
wherein when the generation of the correspondence information is requested by the generation requesting apparatus and if the correspondence information exists, the master controller initializes the existing correspondence information and newly generates correspondence information.

10. The communication system according to claim 8,
wherein when the generation of the correspondence information is requested by the generation requesting apparatus, the master controller requests a password from the generation requesting apparatus, and if a proper password is transmitted from the generation requesting apparatus, generates the correspondence information.

11. The communication system according to claim 2,
wherein the master controller generates a random number, and transmits the generated random number as the first identifier request to each apparatus from the master communicator,
wherein when the first identifier request is received, the encryptor of each apparatus encrypts the random number being the first identifier request and the identifier together by the first secret information to generate the encrypted identifier, and
wherein the master controller obtains the encrypted identifier from each apparatus with the master communicator, decrypts the obtained encrypted identifier by the second secret information, and if the decrypted encrypted identifier includes the transmitted random number, extracts a portion of the decrypted encrypted identifier that excludes the random number, as the identifier, and generates a correspondence between the extracted identifier and the assigned initial address, as the correspondence information.

12. The communication system according to claim 11,
wherein when starting the communication again after creating the correspondence information, the master controller generates a random number and transmits the generated random number as the second identifier request to each apparatus from the master communicator,
wherein when the second identifier request is received, the encryptor of each apparatus encrypts the random number being the second identifier request and the identifier together by the first secret information to generate the encrypted identifier, and
wherein the master controller obtains the encrypted identifier, which has been generated as a result of receiving the second identifier request, from each apparatus with the master communicator, decrypts the obtained encrypted identifier by the second secret information, and if the decrypted encrypted identifier includes the transmitted random number, extracts a portion of the decrypted encrypted identifier that excludes the random number, as the identifier, and checks whether or not a pair of the extracted identifier and the communication start address corresponding to the decrypted encrypted identifier exits in the correspondence information.

13. A master apparatus to perform communication with each apparatus of a plurality of apparatuses, each being connected at each connection position which determines an address order, the master apparatus comprising:
a master communicator to perform communication with each apparatus, which includes a memory to store an identifier and first secret information and an encryptor to encrypt the identifier by the first secret information, as the plurality of apparatuses;
a master memory to store second secret information; and
a master controller to assign, to each apparatus, an address in accordance with the address order and to be used for the communication, as an initial address, transmit a first identifier request for requesting an identifier to each apparatus from the master communicator using the initial address, obtain an encrypted identifier, which has been generated by each apparatus by encrypting the identifier by the first secret information, from each apparatus with the master communicator, decrypt the obtained encrypted identifier by the second secret information, and generate correspondence information which indicates a correspondence between the decrypted identifier and the initial address used to obtain the decrypted identifier.

14. The master apparatus according to claim 13,
wherein when starting the communication again through the master communicator after creating the correspondence information, the master controller assigns the address to each apparatus as a communication start address, transmits a second identifier request for requesting the identifier again to each apparatus from the master communicator using the communication start address, obtains an encrypted identifier, which has been generated by encrypting the identifier by the first secret information as a result of receiving the second identifier request, from each apparatus with the master communicator, decrypts the obtained encrypted identifier by the second secret information, and checks whether or not a pair of the decrypted identifier and the communication start address used to obtain the decrypted identifier exists in the correspondence information.

15. The master, apparatus according to claim 14,
wherein each apparatus has an attribute of the apparatus as the identifier,
the master apparatus further comprising a master rule file memory to store a rule file which describes a rule to be satisfied by the attribute,
wherein after obtaining the encrypted identifier, which has been generated as a result of receiving the second identifier request, from each apparatus with the master communicator, the master controller determines whether or not the decrypted identifier conforms to the rule in the rule file.
